(19) United States
(12) Patent Application Publication
(10) Pub. No.: US 2020/0075991 A1
(43) Pub. Date: Mar. 5, 2020

(54) MEDIUM-LOW HEAT DRIVEN SODIUM-BASED SECONDARY BATTERY AND MANUFACTURING METHOD THEREFOR

(71) Applicant: RESEARCH INSTITUTE OF INDUSTRIAL SCIENCE & TECHNOLOGY, Gyeongsangbuk-do (KR)

(72) Inventors: Keeyoung JUNG, Pohang-si (KR); Yoon-Cheol PARK, Busan (KR); Sang-Rok OH, Pohang-si (KR); Sang-Lag LEE, Pohang-si (KR); Nam-Woong CHO, Pohang-si (KR); Hyeon-Woo KIM, Pohang-si (KR); Go-Un KIM, Pohang-si (KR); Sori SON, Pohang-si (KR)

(21) Appl. No.: 16/463,211

(22) PCT Filed: Dec. 26, 2016
(86) PCT No.: PCT/KR2016/015288

§ 371 Date: May 22, 2019

(30) Foreign Application Priority Data
Nov. 23, 2016 (KR) 10-2016-0156568
Nov. 23, 2016 (KR) 10-2016-0156569

(51) Int. Cl. H01M 10/054; H01M 2/08; H01M 10/0562

(52) U.S. Cl. CPC H01M 10/054; H01M 2300/0071; H01M 10/0562; H01M 2/08

(57) ABSTRACT

The present invention relates to a sodium secondary battery comprising: an anode container for accommodating sodium; a cathode container for accommodating a cathode active material and a cathode secondary electrolyte; a solid electrolyte positioned between the anode container and the cathode container and selectively moving sodium ions; and a polymer sealing layer formed along the edge of the solid electrolyte and positioned between the solid electrolyte and the anode container and between the solid electrolyte and the cathode container. Since the sodium secondary battery of the present invention uses the polymer sealing layer, an expensive bonding process and an expensive bonding facility are unnecessary, the number of parts of a single cell can be reduced, and a battery manufacturing process can be simplified.

### TECHNICAL FIELD

The present disclosure relates to a sodium-based secondary battery capable of operating at moderate to low temperatures, and a method of preparing the same.

### BACKGROUND ART

Sodium-based batteries operating at high temperatures (sodium-sulfur batteries, sodium-metal halide batteries, etc.) have high energy density and charge-discharge efficiency, and do not suffer from self-discharge or performance deterioration, even when operated for long periods of time. Due to these advantages, sodium-based batteries have been commercialized and widely used as power storage batteries.

High-temperature sodium-based batteries are secondary batteries being operated at temperatures of 280-350° C., and which are prepared using molten metallic sodium (Na) as an anode active material and sulfur (S) or a metal halide (NiCl₂, FeCl₂, etc.) as a cathode active material, respectively, wherein the anode active material and the cathode active material are separated from each other by a beta-alumina solid electrolyte. Furthermore, the high-temperature sodium-based batteries are sealed with an Al-, Ni- or Fe-based alloy or a sealing glass member.

Implementing long-term sealing characteristics applicable to operations at 280-350° C., however, necessitates the presence of heterojunctions between a ceramic solid electrolyte and ceramic insulator member, and between the ceramic insulator and external member, further necessitates a glass sealing and thermal compression bonding process, respectively, to have the heterogeneous members bonded to each other using a filler therebetween.

The aforementioned processes require costly equipment with complex structures, and due to thermal stress issues caused by variations in thermal expansion coefficients, sodium-based batteries are often manufactured as cylinder types using solid electrolyte and having relatively small diameters.

### DISCLOSURE

### Technical Problem

To operate a battery in an operating temperature range (−300° C.) of conventional Na—NiCl₂ batteries, the battery is required to have a leak rate in the range of 10⁻³-10⁻¹⁰ mbar·L/sec to suppress reactions with active materials, oxygen in the atmosphere and the like. Therefore, single batteries have been manufactured using costly bonding methods that require high temperature, high pressure, and high vacuum, such as thermal compression bonding (TCB), glass sealing, electron beam welding, and laser welding.

In light of the foregoing, one object of the present disclosure is to provide a sodium-based battery capable of operating at moderate to low temperatures of 200° C. or less, and which contains significantly fewer components and has a dramatically simplified manufacturing process by using polymer materials for metal-metal, ceramic-ceramic, and ceramic-metal junctions.

Furthermore, another object of the present disclosure is to improve long-term sealing characteristics of a sodium-based secondary battery capable of operating at moderate to low temperatures of 200° C. or less, and in which polymer materials are used at ceramic-metal junctions to bond ceramic components and metal components to each other.

### Technical Solution

According to one aspect of the present disclosure, a sodium-based secondary battery includes: an anode chamber configured to accommodate sodium; a cathode chamber configured to accommodate a cathode active material and a catholyte; a solid electrolyte between the anode chamber and the cathode chamber to selectively allow sodium ions to pass through; and polymer sealing layers disposed along an edge of the solid electrolyte and disposed between the solid electrolyte and the anode chamber and between the solid electrolyte and the cathode chamber.

The polymer sealing layers may include at least one selected from polyethylene, high molecular polyethylene, polyimide, thermoplastic polyimide, polyvinylidene fluoride, polytetrafluoroethylene, perfluoroalkoxy alkane, polyether ether ketone, and fluorinated ethylene propylene.

The polymer sealing layers may include: an inner anode-sealing layer disposed along the edge of the solid electrolyte and disposed between the solid electrolyte and the anode chamber, and an outer anode-sealing layer disposed outside the inner anode-sealing layer; and an inner cathode-sealing layer disposed along the edge of the solid electrolyte and disposed between the solid electrolyte and the cathode chamber, and an outer cathode-sealing layer disposed outside the inner cathode-sealing layer.

The inner anode-sealing layer may include at least one of polyethylene and polyvinylidene fluoride.

The inner cathode-sealing layer may include at least one selected from polyethylene, polytetrafluoroethylene, fluorinated ethylene propylene, and perfluoroalkoxy alkane.

The outer anode-sealing layer may include at least one selected from polyimide, perfluoroalkoxy, polyester ether ketone, fluorinated ethylene propylene, polyvinylidene fluoride, thermoplastic polyetherimide, and silicone resin.

The outer cathode-sealing layer may include at least one selected from polyimide, perfluoroalkoxy, polyester ether ketone, fluorinated ethylene propylene, polyvinylidene fluoride, thermoplastic polyetherimide, and silicon resin.

The solid electrolyte may include at least one of beta-alumina and NaSiCon, and their derivatives.

The thickness of the solid electrolyte may be in the range from 100 um to 3 mm.

The cathode active material may include at least one of Ni, Fe, Cu, and Zn; at least one of Al, NaI, NaF, S, and FeS; and NaCl.

The cathode electrolyte may include at least one of NaAlCl₄, NaAlCl₄—NaAlBr₄, NaAlCl₄—LiCl, and NaAlCl₄—LiBr.

The operating temperature for the sodium secondary battery may be in the range of 95−250° C.

According to another aspect of the present disclosure, there is provided a method of preparing a sodium-based secondary battery which includes: an anode chamber configured to accommodate sodium; a cathode chamber configured to accommodate a cathode active material and a catholyte; a solid electrolyte disposed between the anode chamber and the cathode chamber to selectively allow sodium ions to pass through; an inner anode-sealing layer formed along an edge of the solid electrolyte and disposed between the solid electrolyte and the anode chamber, and an outer anode-sealing layer disposed outside the inner anode-sealing layer; and an inner cathode-sealing layer disposed along the edge of the solid electrolyte and disposed between the solid electrolyte and the cathode chamber, and an outer cathode-sealing layer disposed outside the inner cathode-sealing layer, wherein the inner anode-sealing layer, the outer anode-sealing layer, the inner cathode-sealing layer, and the outer cathode-sealing layer are formed by thermal compression.

The thermal compression may be conducted at a temperature in the range of 100−400° C.

### Advantageous Effects

The sodium-based secondary battery of the present disclosure uses polymer sealing layers to thereby eliminate the need for costly bonding processes and expensive bonding equipment, reduce the number of parts of a unit cell, and simplify a battery manufacturing process.

Furthermore, in the sodium-based secondary battery of the present disclosure, the rate of degradation of cathode materials may dramatically decrease as the operating temperature decreases.

Furthermore, a secondary battery including the sealing layers of the sodium-based secondary battery of the present disclosure may have improved long-term sealing characteristics using one polymer sealing layer suitable for the anode part, and another polymer sealing layer suitable for the cathode part to seal the battery, and also by having a sealing layer with desirable reaction resistance in a relatively more inward position within a junction portion and a sealing layer with desirable heat resistance in a relatively more outward position within the junction portion.

### DESCRIPTION OF DRAWINGS

FIG. 1 is a schematic diagram of a sodium-based secondary battery according to an example embodiment of the present disclosure;

FIG. 2 is a schematic diagram of a sodium-based secondary battery according to another example embodiment of the present disclosure;

FIG. 3 shows charge-discharge characteristics of a sodium-based secondary battery of Embodiment 1 of the present disclosure;

FIG. 4 shows charge-discharge cycling characteristics of a sodium-based secondary battery of Embodiment 2 of the present disclosure;

FIG. 5 shows charge-discharge cycling characteristics of a sodium-based secondary battery of Comparative Embodiment 1 of the present disclosure;

FIG. 6 shows charge-discharge cycling characteristics of a sodium-based secondary battery of Embodiment 3 of the present disclosure; and

FIG. 7 shows charge-discharge cycling characteristics of a sodium-based secondary battery of Comparative Example 2 of the present disclosure.

### BEST MODE FOR INVENTION

Hereinbelow, exemplary embodiments of the present disclosure will be described with reference to specific example embodiments. However, it should be apparent to a person skilled in the art that variations can be made within the example embodiments disclosed herein without departing from the scope of the present disclosure, and therefore it should be understood that the scope of the present disclosure is not limited to the example embodiments disclosed herein.

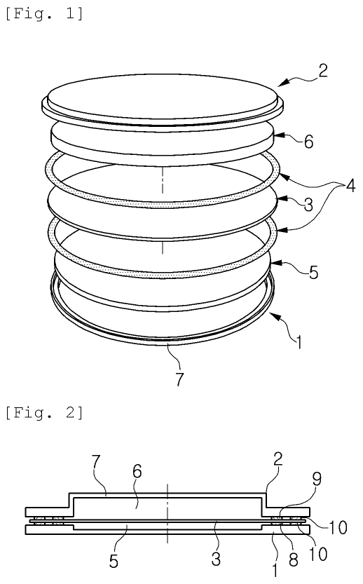

FIG. 1 schematically illustrates a cross-section of a sodium-based secondary battery according to an example embodiment of the present disclosure. Hereinbelow, a sodium-based secondary battery of the present disclosure will be described in greater detail with reference to FIG. 1. However, the following detailed description is provided for illustrative purposes only, and therefore should not be construed as limiting the scope of the present disclosure.

A sodium-based secondary battery 7 of the present disclosure, as illustrated in FIG. 1, includes an anode chamber 1, a cathode chamber 2, and a solid electrolyte 3. The anode chamber 1 and the cathode chamber 2 are disposed on the outside of the sodium battery with the solid electrolyte 3 disposed therebetween to form an outer appearance of the sodium battery, and are configured to accommodate contents therein.

The anode chamber 1 is configured to accommodate sodium therein and may be made of a metal material such as aluminum, stainless steel, and the like. A surface of the anode chamber 1 may be coated with a corrosion-resistant layer which includes chromium, molybdenum, and the like, as a main ingredient. The anode chamber 1 also acts as an external terminal of the anode.

The cathode chamber 2 is configured to accommodate a cathode active material and a catholyte therein and is disposed on one side of the solid electrolyte, facing the anode chamber 1.

The cathode chamber 2, similarly as in the anode chamber 1, may be made of a metal material such as aluminum, stainless steel, and the like. Also, similarly as in the anode chamber 1, a surface of the cathode chamber 2 may be coated with a corrosion-resistant layer that includes chromium, molybdenum, or the like, as a main ingredient. Also, the cathode chamber 2 acts as an external terminal of the cathode.

The cathode active material accommodated in the cathode chamber may include: at least one selected from Ni, Fe, Cu, and Zn; at least one selected from Al, NaI, NaF, S, and FeS; and NaCl.

The catholyte accommodated with the cathode active material in the cathode chamber may be NaAlCl₄, NaAlCl₄⁻NaAlBr₄, NaAlCl₄⁻LiCl, or NaAlCl₄⁻LiBr, and is preferably NaAlCl₄.

The sodium-based secondary battery of the present disclosure, based on its charged state, uses liquid sodium (Na) as the anode active material and NiCl₂ as the cathode active material.

Since the battery is assembled in its discharged state, nickel (Ni) powder and salt (NaCl) powder are used as cathode material, and NaAlCl₄ (sodium alumino tetra-chloride) is used as the catholyte (or liquid electrolyte).

When charging, sodium ions (Na⁺) in the NaCl and the NaAlCl₄ migrate to the anode part to be reduced and form Na 1, and at the same time, at the cathode part, chloride ions (Cl⁻), now having increased activity, react with the nickel (Ni) powder and form NiCl₂.

Here, the solid electrolyte 3 is disposed between the anode chamber 1 and the cathode chamber 2 while making contact with the anode chamber 1 and the cathode chamber 2, to separate the liquid sodium from the positive active material and the catholyte, wherein the solid electrolyte 3 selectively allows only the sodium ions of the anode active material, the cathode active material, and the cathode material to pass through, thereby electrically insulating the cathode chamber 1 and the anode chamber 2 from each other.

The solid electrolyte is not limited to the aforementioned materials and may be any material that exhibits sodium ion conductivity and is applicable to sodium secondary batteries using solid electrolyte. For example, the solid electrolyte may be beta-alumina solid electrolyte (BASE, β/β″—Al₂O₃), NaSiCon, and the like, serving as a separator, and is preferably beta-alumina.

It is advantageous to maintain sodium ion (Na⁺) conductivity of the solid electrolyte for maximizing the performance of a battery. Therefore, as the thickness of the solid electrolyte decreases and the operating temperature of the battery increases, sheet resistance of the solid electrolyte advantageously decreases. Therefore, although not particularly limited in the present disclosure, the thickness of the solid electrolyte may be in the range of about 100 um to about 3 mm.

The liquid sodium accommodated in the anode chamber 1 or the catholyte accommodated in the cathode chamber 2, when leaked, may degrade safety characteristics of the battery. Accordingly, the solid electrolyte 3, the anode chamber 1, and the cathode chamber 2 are sealed by the sealing layers to prevent liquid leakage from the respective chambers.

Conventionally, the battery is sealed using a thermocompression bonding method using inserted metal material, such as aluminum, to prevent such liquid leakage at metal-ceramic junctions; however, imparting long-term sealing characteristics to a sodium-based battery undesirably requires the presence of a heterojunction between solid electrolyte ceramic and an external metal member, a high-temperature thermocompression process at 550-1,500° C. using an Al-based or Mo-based filler, and the like.

In this context, the present disclosure utilizes polymer sealing layers 4 formed of a polymer material for the sealing layers described above. By using the polymer sealing layers 4 as described in the present disclosure, the battery manufacturing process can be designed to be inexpensive and uncomplicated without using costly thermocompression processes, and a battery operating temperature can be lowered to a temperature compatible with an inexpensive bonding process. Furthermore, the battery thus manufactured can operate at 200° C. or below.

The polymer sealing layers may use any polymer material that has excellent heat resistance and can be used at a battery operating temperature, and examples of such polymer material include polyethylene, high molecular polyethylene, polyimide, thermoplastic polyimide, polyvinylidene fluoride, polytetrafluoroethylene, perfluoroalkoxy alkane, polyether ether ketone, and fluorinated ethylene propylene. Preferably, the polymer sealing layer uses high molecular polyethylene.

Temperatures at which thermostable polymers can be continuously used are typically about 220° C.; however, if there exist materials that can be continuously used at temperatures of 220° C. or higher, the present disclosure can be also applied at higher temperatures.

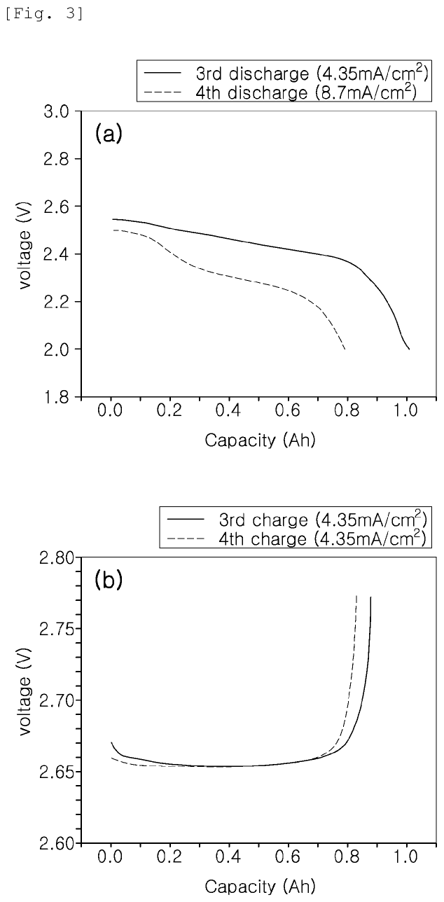

Furthermore, the same material can be used for the polymer sealing layers used to seal the anode chamber and the cathode chamber; however, it is preferable to separately use anode sealing layers disposed in contact with a sodium anode accommodated in the anode chamber, and cathode sealing layers disposed in contact with NaAlCl₄ liquid electrolyte. FIG. 2 is a schematic diagram in which the anode sealing layers and the cathode sealing layers are used separately, as described above.

For example, the polymer sealing layers may include an inner anode-sealing layer 8 disposed along an edge of the solid electrolyte and disposed between the solid electrolyte and the anode chamber, and an outer anode-sealing layer 10 disposed outside the inner anode-sealing layer 8; and an inner cathode-sealing layer 9 disposed along the edge of the solid electrolyte and disposed between the solid electrolyte and the cathode chamber, and an outer anode-sealing layer 10 disposed outside the inner cathode-sealing layer.

The inner anode-sealing layer 8 may use any polymer that demonstrates no reactivity or little reactivity with sodium. The inner anode-sealing layer 8, for example, may use polyethylene, polyvinylidene fluoride, or the like. Preferably, the inner anode-sealing layer 8 uses polyethylene, but is not limited thereto.

Also, the inner cathode-sealing layer 9 may use any material that demonstrates low reactivity with the catholyte, and may use, for example, polyethylene, polytetrafluoroethylene, fluorinated ethylene propylene, perfluoroalkoxy, perfluoroalkoxy alkane, or the like. Preferably, the inner cathode-sealing layer 9 uses polyethylene.

Also, to achieve thermal stability at high temperatures of 200° C. or above, it is preferable that outer sealing layers 10 be additionally disposed outside the inner anode-sealing layer 8 and the inner cathode-sealing layer 9.

Accordingly, the outer anode-sealing layer 10 may use, for example, polyimide, perfluoroalkoxy, polyester ether ketone, fluorinated ethylene propylene, polyvinylidene fluoride, thermoplastic polyetherimide, silicon resin, or the like, and preferably polyimide.

The outer cathode-sealing layer 10 may use, for example, polyimide, perfluoroalkoxy, polyester ether ketone, fluorinated ethylene propylene, polyvinylidene fluoride, thermoplastic polyetherimide, silicon resin, or the like. Preferably, the outer cathode-sealing layer 10 uses polyimide.

As described herein, various polymers were tested for reactivity with sodium and reactivity of NaAlCl₄ liquid electrolyte at moderate to low temperatures of 200° C. or below, to determine polymer materials suitable for a cathode and an anode. As described above, it is preferable that a material with excellent sodium resistance be applied to the anode and a material with excellent NaAlCl₄ resistance be applied to the cathode, separately. Accordingly, a material with excellent reaction resistance can be positioned more inwardly in the junction portion while a material with excellent thermal resistance is positioned more outwardly in the junction portion to improve long-term sealing characteristics of the battery.

The operating temperature of the sodium-based secondary battery can be adjusted, depending on the material used for the sealing layers. For example, the operating temperature may be in the range of 95-250° C., and preferably in the range of 170-220° C.

By lowering the operating temperature of the sodium-based secondary battery, it is possible to replace conventional costly bonding methods requiring high temperature, high pressure, and high vacuum (e.g., thermal compression bonding, glass sealing, electron beam welding, and laser welding) with an inexpensive simple bonding method such as polymer bonding and the like.

The polymer sealing layers described above, namely, the inner anode-sealing layer, the outer anode-sealing layer, the inner cathode-sealing layer, and the outer cathode-sealing layer, may be formed by a thermocompression process.

Although the inner anode-sealing layer, the outer anode-sealing layer, the inner cathode-sealing layer, and the outer cathode-sealing layer are not limited to a thermocompression process; however, since sealing a sodium-based secondary battery by using a thermocompression process is inexpensive and convenient in terms of convenience of operation, the thermocompression process may be preferable.

The thermocompression process, although it varies on the material used for the sealing layers, may be performed at a temperature in the range of 100-400° C., and may be preferably performed in the range of 200-350° C.

If the present disclosure is to be implemented with a plater type design, the production of a cell can be completed through a single heat-and-press process in a vertical direction after sequentially stacking desired components. The aforementioned scheme may be applied to other cell designs of different shapes, such as tubular shapes.

### MODE FOR INVENTION

Hereinbelow, the present disclosure will be described in greater detail with reference to specific example embodiments. The example embodiments provided herein are only to describe the present disclosure in greater detail and should not be construed as limiting the scope of the present disclosure to the specific example embodiments disclosed.

### EMBODIMENTS

### Embodiment 1

For the cathode part, nickel powder and salt (NaCl) are mixed in a weight ratio of 1.2:1-2:1 and further combined with 0.5-3 wt % of an additive such as Al, NaI, NaF, S, and FeSₓ. The mixture thus obtained is compressed and pulverized to form coarse granules having an average diameter of 400 μm to 1.5 mm, thereby producing cathode active materials.

Next, NaCl of high purity (99% min.) and anhydrous AlCl₃ are mixed with each other in 1:1 ratio and further combined with a small amount of aluminum, and the mixture thus produced was heated to 300° C. in an inert atmosphere, to prepare a catholyte. The prepared catholyte is then placed into a cathode chamber along with the cathode active materials produced above.

For the anode part, sodium is used as an anode active material, and to enable the sodium to be easily wetted on a beta-alumina solid electrolyte interface, a metal wick is inserted so as to be in contact with the solid electrolyte. The metal wick of the anode part is spot-welded so as to enable electrons to easily move to the solid electrolyte interface through the anode chamber.

Shape-machined Fe-based metal plates were used for the cathode chamber and the anode chamber, and the beta-alumina solid electrolyte was positioned between the cathode chamber and the anode chamber.

A battery was prepared using high molecular polyethylene (PE) for the polymer sealing layers and sealed by hot pressing at 200° C.

### Embodiment 2

A sodium-based battery was prepared using, as the polymer sealing layers, polyethylene for the inner anode-sealing layer, polyethylene for the inner cathode-sealing layer, and polyamide for the outer anode-sealing layer and the outer cathode-sealing layer. The sodium-based battery was sealed using the same method as in Embodiment 1 except that the hot pressing was performed at 260° C.

### Embodiment 3

A sodium-based secondary battery was prepared using polyvinylidene fluoride for the anode sealing layer and polytetrafluoroethylene for the cathode sealing layer. The sodium-based secondary battery was sealed using the same method as in Embodiment 2 except that no external bonding material was used.

### Comparative Example 1

A sodium-based secondary battery was prepared using the same method as in Embodiment 2 except that no external bonding material was used.

### Comparative Example 2

A sodium-based secondary battery was prepared using polyimide for the negative inside sealing layer and the inner cathode-sealing layer, and using the same method as in Embodiment 2 except that no external bonding material was used.

### EXPERIMENTAL EXAMPLES

### Experimental Example 1: Charge-Discharge Cycling Characteristics of Sodium-Based Secondary Batteries

FIG. 3 show the results of a charge-discharge test for (a) discharging and (b) charging of the sodium-based secondary battery of Embodiment 1.

In particular, the sodium-based secondary battery of Embodiment 1 was operated at discharge current densities of 4.35 mA/cm² and 8.7 mA/cm², and the cut-off voltage was set to 2.0 V. The charge current density was set to 4.35 mA/cm² and the cut-off voltage was set to 2.77 V.

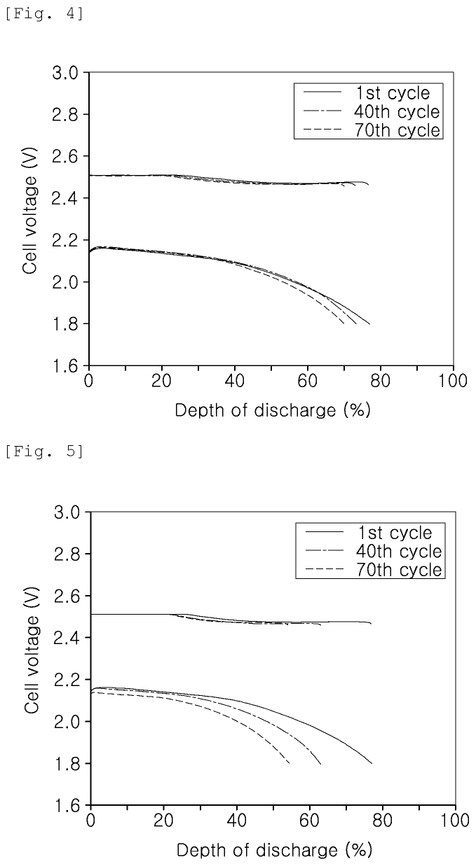

FIG. 4 shows the results of a charge-discharge cycling test of the sodium-based secondary battery of Embodiment 2, and FIG. 5 shows the results of a charge-discharge cycling test of the sodium-based secondary battery of Comparative Example 1.

In particular, in terms of the current density with respect to a reactive surface area of the solid electrolyte, the charge/discharge cycling test were conducted as a constant current operation at 30 mA/cm² for discharging and a constant current operation at 10 mA/cm² for charging. The cut-off voltage for charging switched to a constant voltage operation at 2.52 V, and when the current density reached 5 mA/cm², charging was terminated.

Referring to FIG. 4 and FIG. 5, the battery of Comparative Example 1, due to insufficient heat resistance, suffered degradation of sealing characteristics through charge/discharge cycles, and thus showed a significant decrease in capacity as the sodium contained therein undergoes oxidation.

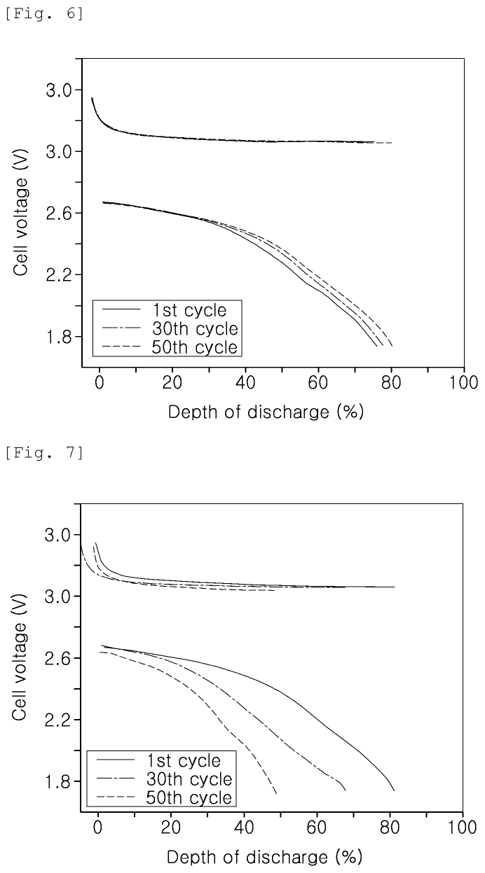

FIG. 6 shows the results of a charge-discharge cycling test for the sodium-based secondary battery of Embodiment 3, and FIG. 7 shows the results of a charge-discharge cycling test for the sodium-based secondary battery of Comparative Example 2.

As can be seen from FIG. 6 and FIG. 7, the battery of Comparative Example 2, due to insufficient chemical resistance, suffered degradation of sealing characteristics through the charge/discharge cycles, and thus showed a significant increase in battery resistance and a significant decrease in capacity.

1. A sodium-based secondary battery, comprising:
an anode chamber configured to accommodate sodium;
a cathode chamber configured to accommodate a cathode active material and a catholyte;
a solid electrolyte disposed between the anode chamber and the cathode chamber to selectively allow sodium ions to pass through; and
polymer sealing layers disposed along an edge of the solid electrolyte and disposed between the solid electrolyte and the anode chamber and between the solid electrolyte and the cathode chamber.

2. The sodium-based secondary battery of claim 1, wherein each of the polymer sealing layers includes at least one selected from polyethylene, high molecular polyethylene, polyimide, thermoplastic polyimide, polyvinylidene fluoride, polytetrafluoroethylene, perfluoroalkoxy alkane, polyether ether ketone, and fluorinated ethylene propylene.

3. The sodium-based secondary battery of claim 1, wherein the polymer sealing layers include:
an inner anode-sealing layer disposed along the edge of the solid electrolyte and disposed between the solid electrolyte and the anode chamber, and an outer anode-sealing layer disposed outside the inner anode-sealing layer; and
an inner cathode-sealing layer disposed along the edge of the solid electrolyte and disposed between the solid electrolyte and the cathode chamber, and an outer cathode-sealing layer disposed outside the inner cathode-sealing layer.

4. The sodium-based secondary battery of claim 3, wherein the inner anode-sealing layer includes at least one selected from polyethylene and polyvinylidene fluoride.

5. The sodium-based secondary battery of claim 3, wherein the inner cathode-sealing layer includes at least one selected from polyethylene, polytetrafluoroethylene, fluorinated ethylene propylene, and perfluoroalkoxy alkane.

6. The sodium-based secondary battery of claim 3, wherein the outer anode-sealing layer includes at least one selected from polyimide, perfluoroalkoxy, polyester ether ketone, fluorinated ethylene propylene, polyvinylidene fluoride, thermoplastic polyetherimide, and silicone resin.

7. The sodium-based secondary battery of claim 3, wherein the outer cathode-sealing layer includes at least one selected from polyimide, perfluoroalkoxy, polyester ether ketone, fluorinated ethylene propylene, polyvinylidene fluoride, thermoplastic polyetherimide, and silicon resin.

8. The sodium-based secondary battery of claim 1, wherein the solid electrolyte includes at least one selected from beta-alumina, NaSiCon, and their derivatives.

9. The sodium-based secondary battery of claim 1, wherein a thickness of the solid electrolyte is in a range from 100 μm to 3 mm.

10. The sodium-based secondary battery of claim 1, wherein the cathode active material includes:
at least one selected from Ni, Fe, Cu, and Zn;
at least one selected from Al, NaI, NaF, S, and FeS; and NaCl.

11. The sodium-based secondary battery of claim 1, wherein the catholyte includes at least one selected from NaAlCl₄, NaAlCl₄—NaAlBr₄, NaAlCl₄—LiCl, and NaAlCl₄—LiBr.

12. The sodium-based secondary battery of claim 1, wherein an operating temperature of the sodium-based secondary battery is in a range of 95-250° C.

13. A method of preparing a sodium-based secondary battery which includes:
an anode chamber configured to accommodate sodium;
a cathode chamber configured to accommodate a cathode active material and a catholyte;
a solid electrolyte disposed between the anode chamber and the cathode chamber to selectively allow sodium ions to pass through; and
polymer sealing layers disposed along an edge of the solid electrolyte and disposed between the solid electrolyte and the anode chamber and between the solid electrolyte and the cathode chamber, wherein the polymer sealing layers are sealed by a thermocompression process.

14. The method of preparing a sodium-based secondary battery of claim 13, wherein the polymer sealing layers include:
an inner anode-sealing layer disposed along an edge of the solid electrolyte and disposed between the solid electrolyte and the anode chamber, and an outer anode-sealing layer disposed outside the inner anode-sealing layer; and
an inner cathode-sealing layer disposed along an edge of the solid electrolyte and disposed between the solid electrolyte and the cathode chamber, and an outer cathode-sealing layer disposed outside the inner anode-sealing layer.

15. The method of preparing a sodium-based secondary battery of claim 13, wherein the thermocompression process is performed at a temperature in a range of 100-400° C.
